(19) United States
(12) Patent Application Publication
(10) Pub. No.: US 2007/0184204 A1
(43) Pub. Date: Aug. 9, 2007

(54) Environmental and Thermal Barrier Coating to Protect a Pre-Coated Substrate

(76) Inventors: Shekar Balagopal, Sandy, UT (US); Akash Akash, Salt Lake City, UT (US); Justin Pendelton, Salt Lake City, UT (US)

Correspondence Address: CERAMATEC, INC., 2425 SOUTH 900 WEST, SALT LAKE CITY, UT, 84119, US

(21) Appl. No.: 11/627,302

(22) Filed: Jan. 25, 2007

Related U.S. Application Data
(60) Provisional application No. 60/762,352, filed on Jan. 25, 2006.

(51) Int. Cl. B05D 1/36

(52) U.S. Cl. 427/419.2

(57) ABSTRACT

An apparatus and method to improve protection of a pre-coated substrate in various environments. The apparatus may include a pre-coated substrate having a substantially porous vapor-deposited coating and one or more non-porous ceramic oxide-based layers applied to the pre-coated substrate by a non-vapor deposition technique. The coefficient of thermal expansion corresponding to the non-porous ceramic oxide-based layer may substantially match the thermal expansion coefficient of the vapor-deposited coating to facilitate thermal compatibility between the two. Further, the non-porous ceramic oxide-based layer may infiltrate pores of the substantially porous vapor-deposited coating to provide a well-bonded hermetic seal that limits fluid access to the pre-coated substrate through the substantially porous vapor-deposited coating.

### RELATED APPLICATIONS

This application claims priority to U.S. Provisional Patent No. 60/762,352 filed on Jan. 25, 2006 and entitled ENVIRONMENTAL BARRIER COATINGS.

### U.S. GOVERNMENT INTEREST

This invention was made with government support under Contract No. DEFG-0203ER83620 awarded by the U.S. Department of Energy. The government has certain rights in the invention.

### BACKGROUND OF THE INVENTION

1. Field of the Invention

This invention relates to environmental barrier coatings and, more particularly, to environmental barrier coatings to protect a pre-coated substrate from corrosion in gaseous, aqueous, and particulate containing environments.

2. Description of the Related Art

Environmental barrier coatings (“EBCs”) have been developed to protect components in gas turbine engines and other harsh environments. EBCs are technologically important because of their ability to enable higher operating temperatures and reduced cooling requirements, thereby enabling the turbine component systems to achieve higher operating efficiencies, lower emissions, and increased performance.

Such coatings, however, are vulnerable to cracking and delamination as a result of thermal cycling and thermal gradients existing between the EBC and the base substrate. For example, it has been observed that zirconium oxide and aluminum oxide EBCs deposited on alloy, ceramic or ceramic pre-coated substrates at temperatures below 1000° C. tend to crack from residual stresses when heated to operating temperatures. Differential stresses increase as the coating thickness increases when there are mismatches between the coefficient of thermal expansion associated with the oxide coating and that associated with the alloy substrate. As a result, although certain types of zirconium oxide and aluminum oxide EBCs appear to demonstrate desirable chemical and mechanical properties, they may nevertheless fail as a result of a mismatch between their coefficients of thermal expansion and that of the substrate.

Known EBCs also tend to demonstrate an inherent porosity that permits access to gases and water vapor, both of which may contribute to coating failure. Mullite (3Al₂.O₃.2SiO₂), for example, is commonly considered an attractive coating for protecting silicon carbide-based ceramics at temperatures above 1400° C. because its coefficient of thermal expansion is similar to that of silicon carbide. Although advanced plasma-sprayed mullite coatings have been shown to perform very well under oxidizing and reducing conditions, their performance in the presence of water vapor and carbon monoxide has been shown to be very poor. These problems may be exacerbated in an Integrated Gasification Combined Cycle (“IGCC”), gas and steam turbines and airfoil system, where EBCs are exposed to a high temperatures, wet reducing and oxidizing environment and to impurities typical of coal-derived syngas, including ash and other alkali content.

Some commercially available substrates for use in IGCC systems and other harsh environments include a pre-applied EBC. The convenience of having an EBC pre-applied, however, may be outweighed by the EBC's inherent inability to protect the substrate against contaminants in a high-temperature, aqueous environment. Particularly, many commercially available pre-coated substrates apply an EBC by a vapor deposition method such as physical vapor deposition, (“PVD”), electron beam physical vapor deposition (“EB-PVD”), and the like. These methods of EBC application produce an inherently porous coating structure that is particularly susceptible to failure due to water vapor and other gases accessing the substrate through the EBC.

In view of the foregoing, what is needed is a high-performance environmental and thermal barrier coating to protect pre-coated substrates from corrosion in a high-temperature gaseous, aqueous, and particulates environment. Beneficially, such an environmental barrier coating would demonstrate improved corrosion resistance in a reducing environment, enhanced bonding with the pre-applied EBC, increased thermo-mechanical compatibility with the pre-applied EBC, increased thermo-chemical stability with ambient gases, and decreased costs of manufacture. Such an environmental and thermal barrier coating is disclosed and claimed herein.

### SUMMARY OF THE INVENTION

The present invention has been developed in response to the present state of the art, and in particular, in response to the problems and needs in the art that have not yet been fully solved by currently available environmental barrier coatings for use on pre-coated substrates. Accordingly, an environmental barrier coating to protect a pre-coated substrate has been developed that demonstrates high performance corrosion resistance in a high-temperature aqueous environment.

In one embodiment in accordance with the invention, an apparatus to improve protection of a pre-coated substrate from various environments includes a pre-coated substrate, and at least one non-porous ceramic oxide-based layer applied thereto. The pre-coated substrate includes a substantially porous vapor-deposited coating having a first coefficient of thermal expansion. The green non-porous ceramic oxide-based layer is applied to the pre-coated substrate by a non-vapor deposition technique, such that the non-porous ceramic oxide-based layer infiltrates pores of the substantially porous vapor-deposited coating and upon sintering to densification will provide a hermetic seal limiting gaseous, particulates and fluid access to the pre-coated substrate through the substantially porous vapor-deposited coating. The ceramic oxide-based layer has a second linear coefficient of thermal expansion substantially matching the first linear coefficient of thermal expansion.

The pre-coated substrate may be planar or non-planar, and may include one or more of a ceramic, a ferrous metal, a non-ferrous metal, stainless steel, a metal alloy, a metal superalloy, and Haynes 230® superalloy. The substantially porous vapor-deposited coating may include a ceramic oxide-based coating applied by physical vapor deposition (“PVD”), evaporative deposition, electron-beam physical vapor deposition (“EB-PVD”), sputtering, pulsed laser deposition, high-velocity oxygen fuel thermal spraying, or plasma spray deposition.

In some embodiments, the non-porous ceramic oxide-based layer may include aluminum oxide, doped aluminum oxide, and/or magnesium oxide. Further, the non-porous ceramic oxide-based layer may include a colloidal suspension or slurry, and may be applied by a non-vapor deposition technique such as dip-coating, brush-coating, spraying, spin-coating, or wetting. In certain embodiments, the non-porous ceramic oxide-based layer may have a depth in a range between about one microns (1μ) and about five hundred microns (500μ), and may infiltrate pores of the substantially porous vapor-deposited coating at a depth in a range between about one micron (1μ) and about one hundred and fifty microns (150μ).

A method to protect a pre-coated substrate from corrosion in a high-temperature aqueous environment is also presented. The method may include providing a pre-coated substrate, providing at least one non-porous ceramic oxide-based layer, and applying, via a non-vapor deposition technique, the non-porous ceramic oxide-based layer to the pre-coated substrate. As in the apparatus, the pre-coated substrate has a substantially porous vapor-deposited coating that includes a first coefficient of thermal expansion, and the non-porous ceramic oxide-based layer includes a second coefficient of thermal expansion substantially matching the first coefficient of thermal expansion. Further, the non-porous ceramic oxide-based layer infiltrates pores of the substantially porous vapor-deposited coating to provide a hermetic seal limiting gaseous, particulates, and fluid access to the pre-coated substrate through the substantially porous vapor-deposited coating. The pre-coated substrate may include a planar or non-planar geometry.

Alternatively, another method to protect a pre-coated substrate would be to provide a metal coating (1 micron to 500 micron thick) which is deposited via a non-vapor deposition technique. This layer is then heated at a high enough temperature to melt, oxidize, and sinter the metal layer. The resulting top layer will be substantially non-porous and be present in an oxidized form. The group of metal for this method can be selected from one of aluminum, magnesium, bronze, copper, zinc, manganese, or tin. A suspension of metal powders is made into which the substrate is dipped to get a coating. This is first dried and then fired at high temperature. Alternatively, the metals can also be vapor-deposited first followed by heating (melting) and oxidation step to obtain a dense top coat. The final maximum sintering temperature would be below the melting temperature of the pre-coated substrate.

In certain embodiments, applying via a non-vapor deposition technique may include dip-coating, brush-coating, spraying, spin-coating, or wetting the pre-coated substrate. Further, in some embodiments, the method may include sintering the non-porous ceramic oxide-based layer. Sintering temperature may be controlled to facilitate an increased density of the non-porous ceramic oxide-based layer. In one embodiment, for example, sintering temperature may be set below about 1250° C. In other embodiments, a depth at which the non-porous ceramic oxide-based layer infiltrates pores of the substantially porous vapor-deposited coating may be controlled by varying, for example, the infiltration time, the concentration of the non-porous ceramic oxide-based material, or the viscosity of the non-porous ceramic oxide-based suspension or slurry.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a cross-sectional view of an apparatus including a pre-coated substrate and a non-porous ceramic oxide-based layer in accordance with embodiments of the present invention;

FIG. 2 is a photograph of the apparatus of claim 1;

FIGS. 3A and 3B are graphical representations of thermodynamic calculations pertinent to the stability of magnesium oxide under conditions similar to those encountered in coal-derived syngas environments;

FIG. 4 is an enlarged view of the interface between the pre-coated substrate and the non-porous ceramic oxide-based layer shown in FIG. 2;

FIG. 5 is a cross-sectional view of an embodiment of the present invention having multiple ceramic oxide-based sub-layers;

FIG. 6 is a flow chart illustrating a method for protecting a pre-coated substrate from corrosion in a high-temperature aqueous environment in accordance with certain embodiments of the present invention; and

FIG. 7 is a flow chart depicting a method for manufacturing nano-sized oxide materials for implementation in the ceramic oxide-based layer in accordance with the present invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of apparatus in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As used herein, the term “coefficient of thermal expansion” or “CTE” refers to the linear coefficient of thermal expansion, a mathematical ratio of fractional linear dimensional change of a material relative to the change in temperature of the material, and is (often) reported in terms of ppm/° C. The term “high-temperature” refers to temperatures in a range between about room temperature and about fifteen hundred and fifty degrees Celsius (1550° C). The term “aqueous environment” refers to an environment having a water vapor content of up to one hundred percent (100%).

All amounts, parts, ratios and percentages used herein are by weight unless otherwise specified.

Embodiments of the present invention are provided to improve corrosion resistance in a high-temperature aqueous environment. Particularly, embodiments of the present invention may protect a substrate from corrosion in coal gas impurities such as CaO, Na₂O, K₂O, S, H₂S, SO₃, NH₃ as well as from HCl, H₂SO₄, HNO₃, NaCl, alkali chlorides, sulfides, sulfates, and other chemical environments known to those in the art. Further, certain embodiments of the present invention protect substrates from oxidation and embrittlement as used in solid oxide fuel cells, chemical and petrochemical industries, gas turbines, steam turbines, and IGCC systems. Some embodiments of the present invention may further prevent gas shift reactions of hydrocarbons, H₂O shift reactions, and provide usefulness as an anti-coking coating by preventing coking of hydrocarbons.

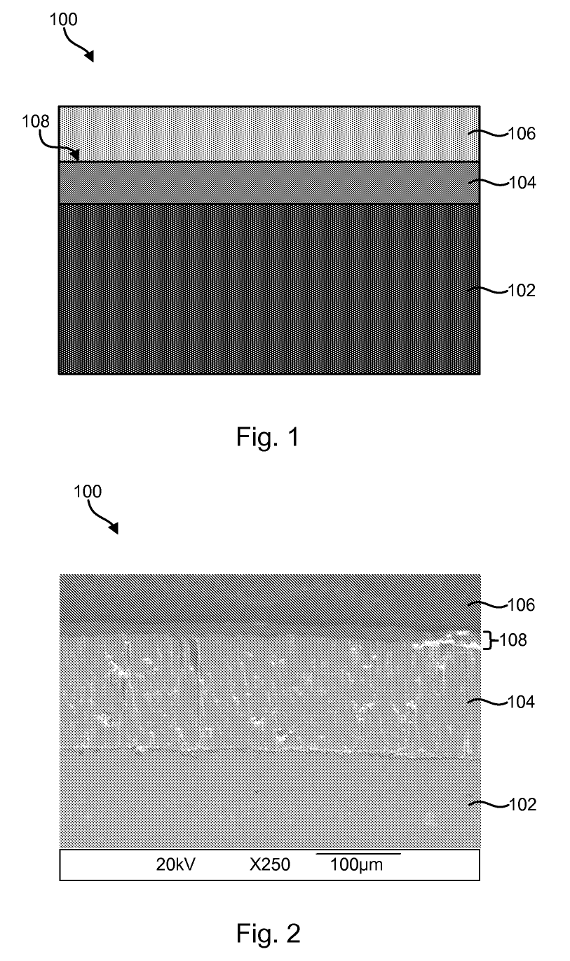

Referring now to FIGS. 1 and 2, an apparatus 100 in accordance with the present invention may include a substrate 102, a vapor-deposited coating 104, and a ceramic oxide-based layer 106. The substrate 102 may include a ceramic, a ferrous or non-ferrous metal, stainless steel, a metal alloy, a metal superalloy, a nickel-based superalloy such as Haynes 230® superalloy, or the like. The substrate 102 may be substantially planar, or may comprise any two or three-dimensional geometry. In some embodiments, the substrate 102 may comprise a component in a gas turbine, steam turbine, or Integrated Gas Combined Cycle (“IGCC”) system. In other embodiments, the substrate 102 may comprise a component in any chemical, petrochemical, catalytic, medical, municipal, airfoil, or other application or industry known to those in the art that is subject to a high-temperature corrosive environment.

In some embodiments, the vapor-deposited coating 104 maybe commercially pre-applied and, in some cases, may have been previously subjected to an operating environment. The vapor-deposited coating 104 may comprise a substantially porous ceramic oxide-based coating 104 applied by physical vapor deposition (“PVD”), evaporative deposition, electron-beam physical vapor deposition (“EB-PVD”), Chemical Vapor deposition (CVD), sputtering, pulsed laser deposition, high-velocity oxygen fuel thermal spraying, plasma spray deposition, or by any other vapor deposition method known to those in the art.

The vapor deposition method used to apply the coating 104 may create an open or continuous structure of pores 110, channels, and other cavities extending throughout the coating 104 and communicating with the coating 104 surface, as best depicted by FIG. 1. Vapor-deposited coatings 104 applied by plasma spray (air) techniques tend to create a sponge-like pore structure. Coatings 104 applied by physical (chemical) vapor deposition techniques, on the other hand, tend to create a series of columnar grooves, crevices, or channels in the coating 104. In any case, such porous microstructures ultimately render the coating 104 vulnerable to corrosive liquids and gases. Indeed, corrosive gases and fluids in a wide temperature range, aggressive operating environment may diffuse or migrate through the substantially porous, vapor-deposited coating 104 to react with the underlying substrate 102, causing degradation, corrosion and/or embrittlement.

The ceramic oxide-based layer 106 of the present invention may be applied to the vapor-deposited coating 104 to limit fluid access to the substrate 102 through the vapor-deposited coating 104. Specifically, as discussed in more detail with reference to FIG. 2 below, the ceramic oxide-based layer 106 may be substantially non-porous and may infiltrate pores 110 of the vapor-deposited coating 104 to provide a hermetic seal. Infiltrating pores 110 of the vapor-deposited coating 104 in this manner may also facilitate an adherent bond between the vapor-deposited coating 104 and the ceramic oxide-based layer 106.

In certain embodiments, the ceramic oxide-based layer 106 may comprise magnesium oxide, aluminum oxide, aluminum nitrate, or any other suitable ceramic oxide known to those in the art. The ceramic oxide-based layer 106 may be particularly selected to provide thermochemical stability with respect to ambient gases. For example, sodium, sulfur, ammonia, and other alkali and alkaline components in coal are the primary corrosive agents in an IGCC system where coal-derived syngas is utilized to drive metal turbines. Unlike silica and silicates that easily form binary and ternary compounds with sodium and are therefore not suitable as environmental barrier coatings in an IGCC system, magnesium oxide binary oxides form no stable compounds with sodium. Accordingly, magnesium oxide may provide a suitable ceramic oxide-based layer 106 in an IGCC environment.

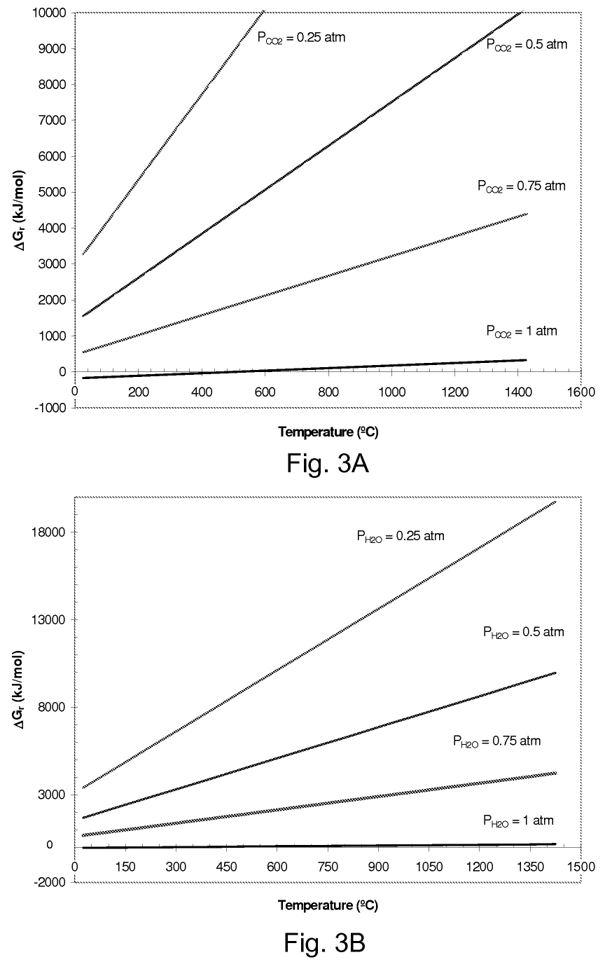

Indeed, magnesium oxide-based compositions also provide excellent stability in moist reducing and oxidizing environments with up to one hundred percent (100%) relative humidity and pressure conditions. The major constituents of coal-derived syngas are hydrogen (H₂), water (H₂O), carbon monoxide (CO) and carbon dioxide (CO₂). It is generally understood that the primary concerns for oxide stability in an IGCC system are due to corrosion from H₂O and CO₂. Thermodynamic calculations, graphically depicted by FIGS. 3A and 3B, demonstrate the stability of magnesium oxide in CO₂ and H₂O conditions similar to those encountered in coal-derived syngas for the reactions indicated below:
MgO+CO₂→MgCO₃
MgO+H₂O→Mg(OH)₂

As shown by FIGS. 3A and 3B, the free energy of reaction of both Mg(OH)₂ and MgCO₃ by reaction of magnesium oxide with H₂O and CO₂ increases as temperature increases, and as the partial pressures of each of H₂O and CO₂ decrease. In other words, the stability of magnesium oxide increases with increased temperature and with decreased partial pressures of H₂O and CO₂. Typically, syngas compositions include between about five and about twenty percent (5%-20%) H₂O, and between about two and fifteen percent (5%-15%) CO₂. As shown in FIGS. 3A and 3B, magnesium oxide is expected to be very stable under these conditions. Accordingly, implementing magnesium oxide as a primary component of the ceramic oxide-based layer 106 of the present invention may provide substantial stability in an IGCC syngas environment.

In certain embodiments, the ceramic oxide-based layer 106 may include one or more dopants to improve adhesion, provide thermal grading between the substrate 102, the vapor-deposited coating 104, and the ceramic oxide-based layer 106, and/or improve thermochemical stability at lower temperatures than conventional ceramics, aiding with sintering of aluminum oxide or magnesium oxide based layer 106, and increasing the toughness of aluminum oxide or magnesium oxide material through transformation toughening. Suitable dopants may include, for example, cerium, yttrium, aluminum, zirconium, iron, titanium, nickel, or any other suitable dopant known to those in the art.

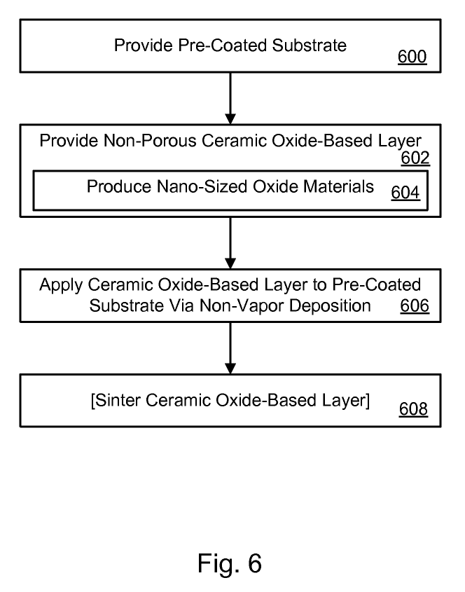

The ceramic oxide-based layer 106 of the present invention may be applied by to the vapor-deposited coating 104 by dip-coating, brush-coating, spraying, spin-coating, wetting, or by any other suitable non-vapor deposition method, as discussed in more detail with reference to FIG. 6 below. The ceramic oxide-based layer 106 may be sintered in an inert environment at high temperature, ranging between about 900° C. and about 1300° C., for example.

In some embodiments, coefficients of thermal expansion (“CTE”) corresponding to each of the substrate 102, the vapor-deposited coating 104, and the ceramic oxide-based layer 106 may be substantially graded to permit thermal cycling across a wide temperature range, where such thermal cycling may not damage, disrupt, or separate the ceramic oxide-based layer 106 from the vapor-deposited coating 104. In other embodiments, a CTE of the ceramic oxide-based layer 106 may be substantially matched to the CTE of the substrate 102 and/or to the CTE of the vapor-deposited coating 104. Grading or matching the CTEs of each compositional layer 102, 104, 106 in this manner allows for thermal cycling across a wide temperature range. In one embodiment, for example, thermal expansion grading between the substrate 102, the vapor-deposited coating 104, and the ceramic oxide-based layer 106 allows for thermal cycling across temperatures ranging from about room temperature to about 1300° C., or to the melting point of the substrate 102.

In certain embodiments, the substrate 102 may comprise a first CTE, the ceramic oxide-based layer 106 may comprise a second CTE, and the vapor-deposited coating 104 may comprise a third CTE, where the third CTE is substantially intermediate the first and second CTEs. In some instances, a difference between CTEs corresponding to the vapor-deposited coating 104 and the ceramic oxide-based layer 106 may be less than about ten (1-2) ppm/° C. In other embodiments, a difference between CTEs corresponding to the vapor-deposited coating 104 and the ceramic oxide-based layer 106 may be between about one-half (0.5) and about one (1) ppm/° C. Closely grading the CTEs of the vapor-deposited coating 104 and the ceramic oxide-based layer 106 in this manner may alleviate stresses otherwise resulting at an interface 108 between the layers 104, 106 due to changes in temperature.

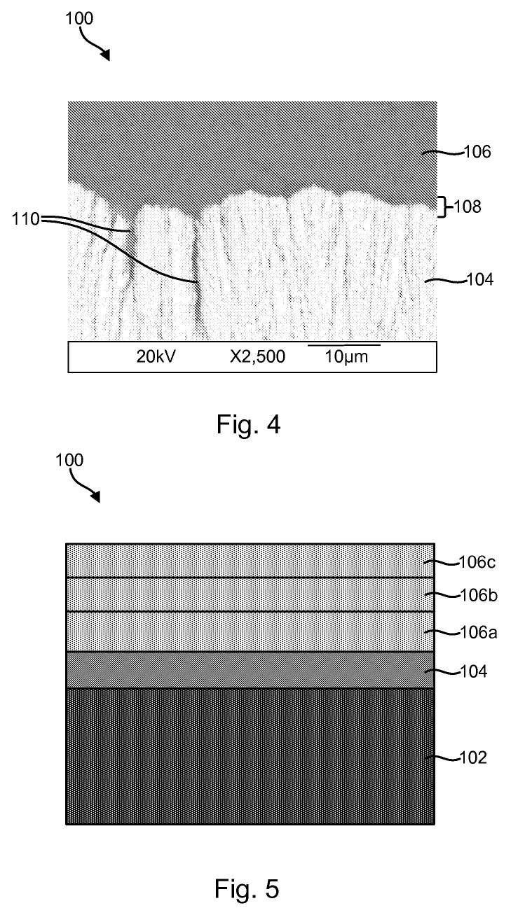

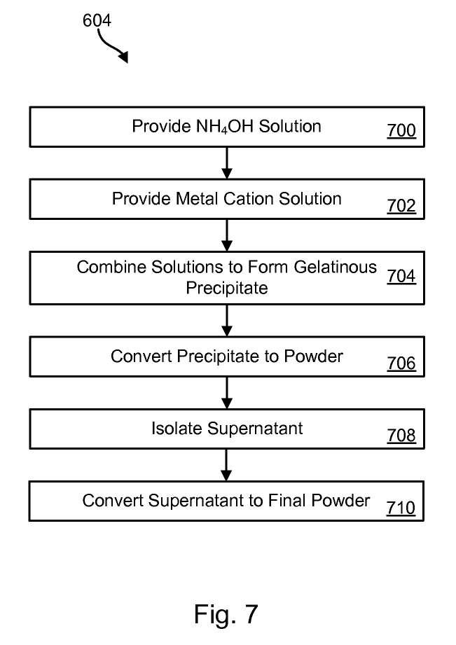

Referring now to FIG. 4, the ceramic oxide-based layer 106 may be applied to the vapor-deposited coating 104 such that the ceramic oxide-based layer 106 infiltrates coating 104 pores 110. In some embodiments, the ceramic oxide-based layer 106 may comprise nanoparticles to facilitate pore 110 infiltration, as discussed in more detail with reference to FIG. 7 below. As used throughout this application, “nano-particles” or “nano-sized particles” are particles having an average diameter of between about 1 nanometer and about 100 nanometers. As also used throughout this application, “micro-particles” “micron-particles” “micron-sized particles” “micro-sized particles” are particles having an average diameter of between about 0.1 microns and about 20 microns. The terms “nano” “micro” and “micron” refer to the ranges set forth above.

The extent to which the ceramic oxide-based layer 106 infiltrates the coating 104 pores 110 may be controlled by varying a cation concentration of the ceramic oxide-based layer 106, varying a viscosity of the ceramic oxide-based layer 106, varying an infiltration time during which the ceramic oxide-based layer 106 is permitted to infiltrate coating 104 pores 110, varying application and withdrawal rates of the ceramic oxide-based layer 106 relative to the vapor-deposited coating 104, or by any other means known to those in the art. In certain embodiments, the ceramic oxide-based layer 106 may infiltrate coating 104 pores 110 at a depth in a range between about one micron (1μ) and about one hundred and fifty microns (150μ). In other embodiments, the ceramic oxide-based layer 106 may infiltrate coating 104 pores 110 up to about fifty percent (50%) of the depth of the vapor-deposited coating 104.

Alternatively, in some embodiments a pre-coated substrate is protected by providing a metal coating (1 micron to 500 micron thick) 106 which is deposited via a non-vapor deposition technique. This layer 106 is then heated at a high enough temperature to melt, oxidize, and sinter the metal layer. The resulting top layer 106 will be substantially non-porous and be present in an oxidized form. The group of metal for this method can be selected from one of aluminum, magnesium, bronze, copper, zinc, manganese, or tin. A suspension of metal powders is made into which the substrate is dipped to get a coating. This is first dried and then fired at high temperature. Alternatively, the metals can also be vapor-deposited first followed by heating (melting) and oxidation step to obtain a dense top coat. The final maximum sintering temperature would be below the melting temperature of the pre-coated substrate.

The concentration and viscosity of suspension of slurry made from the ceramic material and other components to be deposited as the green ceramic oxide-based layer 106 may be highly influenced by the components and methods used to make the ceramic oxide-based layer 106. In one embodiment, for example, the ceramic oxide-based layer 106 may comprise a solvent-based suspension of magnesium oxide (MgO). Nano and submicron sized MgO-based material may be dispersed in methyl alcohol or toluene-ethyl alcohol and other polar or non-polar solvents. In some embodiments, MgO-based suspensions demonstrate twenty to forty percent (20%-40%) loading, by weight, in toluene-based solvent mixtures with polyvinyl buterol as a dispersant. The ingredients may be mixed in a nalgene container with yttrium- stabilized zirconium or alumina media about half-filled in the container. The slurry may be de-aired by an ultrasonic process, and then flowed through a nitrogen feed to remove air bubbles. Viscosity of the solvent with loading of MgO up to about sixty percent (60%) may be in a range between about five and twenty centipoises (5-20 cPs), up to about two hundred centipoises (200 cPs).

In another embodiment, the ceramic oxide-based layer 106 may comprise a water-based suspension of MgO. Stable aqueous suspensions with oxide loading of five to twenty percent (5%-50%), by weight, may be prepared using a commercially available Igepal-520® dispersing agent. Viscosity of the water-based suspension may range between six hundred and twelve hundred centipoises (600-1200 cPs), with two percent (2%) organics.

In certain embodiments, application and withdrawal rates may be controlled by utilizing an automated dip-coating method to coat the vapor-deposited coating 104 with the ceramic oxide-based layer 106. A surface of the vapor-deposited coating 104 maybe as-prepared, or cleaned by chemical or ultrasonic method,

The substrate 102 and associated vapor-deposited coating 104 maybe dipped into a solution or slurry bath comprising the ceramic oxide-based layer 106. Care may be taken to control the speed of dipping and withdrawal rates to obtain a uniform green coating. In one embodiment, dipping and withdrawal rates may be about 0.4×10⁻⁴ m/s. The hold time in the solution as well as suspension viscosity and the plane at which the substrate 102 and associated vapor-deposited coating 104 is dipped may determine the quality, thickness, green bonding, and pore 110 infiltration of the ceramic oxide-based layer 106 relative to the vapor-deposited coating 104.

In an alternative embodiment, the ceramic oxide-based layer 106 may comprise a water-based nitrate solution. The water-based nitrate solution may be prepared by mixing and dissolving a single nitrate crystal chemical such as aluminum nitrate, zirconium nitrate, or magnesium nitrate in water. In some embodiments, a combination of one or two nitrate crystals may be dissolved in water in a known molar concentration, such as between about one to fifteen moles (1-15 mol %) of the first nitrate and from 1-85% of the second nitrate crystal. Nano suspensions of aluminum, zirconium, or magnesium based oxides in solvent-based systems may also be used.

The nitrate solution comprising the ceramic oxide-based layer 106 may be placed in a beaker inside a dessicant chamber having the substrate 102 and associated vapor-deposited coating 104 therein. The chamber may then be pumped down to vacuum condition of up to twenty-five mm of mercury (25 mm Hg). The nitrate solution may then be forced to flow or penetrate into the pores 110 of the vapor-deposited coating 104, where the rate of infiltration is controlled by optimizing solution viscosity, cation concentration, and time of exposure. The coated surface may then be heat treated up to about one thousand degrees Celsius (1000° C.) in air, nitrogen, hydrogen, or argon environment to decompose the nitrates and leave deposits of oxides of alumina, zirconium or magnesium inside the pores 110. In other embodiments, pore 110 infiltration may be initiated by applied suction or by a gravity wicking effect without the use of a vacuum method, or by any other means known to those in the art.

### EXAMPLE 1

### Application of EBC on Alloy-Ceramic Coated Substrates

A dense, approximately 10 to 15 microns thick coating of Al₂O₃, doped Al₂O₃ or MgO is applied by dip coating method on to (pre-coated) ceramic oxide-coated Haynes 230 alloy substrates. These substrates were pre-coated yttrium stabilized Zirconium Oxide (YSZ) or Alumina or other ceramic oxides commonly known in the art. Dip coating of nanoparticle suspension of Al₂O₃ on these pre-coated substrates was performed (FIG. 4).

The nano- and micron-sized Al₂O₃ and two doped Al₂O₃ compositions were synthesized and characterized. Due to sintering constraint of Haynes 230 alloy, the Al₂O₃ was tailored to have a low sintering temperature (below 1250° C.). To obtain a uniform coating with homogenous sintering, stable suspensions of nano- and sub-micron-sized Al₂O₃ particles were developed. The Al₂O₃ coating was applied on ceramic coated-Alloy substrate by a dipping and vacuum infiltration method and later fired in air at 1200° C.

Scanning electron microscope images of the fractured cross-sections of Al₂O₃ on YSZ are show in FIG. 4. The coating is approximately 8 to 12 microns in thickness and well bonded. Al₂O₃ penetrates about 50 microns into the porous ceramic oxide coating. The penetration depth was established by controlling the infiltration time, concentration, and the viscosity of suspensions.

This resulted in the application of crack free, dense and well-bonded Al₂O₃ coating on alloy substrates at 1200° C. The doped Al₂O₃ materials developed may potentially allow further lowering of the sintering temperature to make denser coatings.

Referring now to FIG. 5, the ceramic oxide-based layer 106 may be applied as a single layer 106 or as multiple sub-layers 106a, 106b, 106c to achieve a desired thickness. In one embodiment, for example, the ceramic oxide-based layer 106 may exhibit a thickness of between about ten and fifteen microns (10-15μ).

Each sub-layer 106a, 106b, 106c may be sintered as it is applied, or several sub-layers 106a, 106b, 106c may be applied prior to a sintering step. Sintering may be in air, nitrogen, hydrogen, argon, or any other substantially inert environment known to those in the art. In some embodiments, a sintering temperature may be set in a range between about eight hundred and about fifteen hundred degrees Celsius (800-1500° C.) for a duration of between about one and about ten hours (1-10 hrs) to form a dense ceramic oxide-based layer 106 on a vapor-deposited coating 104. In some embodiments, the ceramic oxide-based layer 106 may achieve increased density by isostatic pressing at pressures above about one (1) kpsi.

In one embodiment, an apparatus 100 in accordance with the present invention may comprise a substrate 102 having a vapor-deposited coating 104 and multiple ceramic oxide-based sub-layers 106a, 106b, 106c, where each sub-layer 106a, 106b, 106c comprises nickel-doped magnesium oxide.

In other embodiments, the multiple ceramic oxide-based sub-layers 106a, 106b, 106c may each comprise various oxide materials. In one embodiment, for example, a first and second sub-layer 106a, 106b comprise nickel-doped magnesium oxide while a third sub-layer 106c comprises undoped magnesium oxide. In another embodiment, the third sub-layer 106c comprises aluminum oxide. In any case, each sub-layer 106a, 106b, 106c may comprise microparticles, nanoparticles, or a combination thereof.

As set forth above, each sub-layer 106a, 106b, 106c may comprise the same or varying ceramic oxide-based compositions suitable for providing a hermetic seal limiting gases, fluid or particulates access to the substrate 102 through the vapor-deposited coating 104 in accordance with the present invention. Particularly, the ceramic oxide-based layer 106 and sub-layers 106a, 106b, 106c thereof may include a dopant provided in a concentration tailored to substantially match the CTE of the vapor-deposited coating 104, and/or to provide graded thermal expansion between the substrate 102, the vapor-deposited coating 104, and the ceramic oxide-based layer 106. In other embodiments, dopants may be selected to provide chemical bonding and/or to lower the sintering temperature of the ceramic oxide-based layer 106. Likewise, the ceramic oxide-based layer 106 and sub-layers 106a, 106b, 106c thereof may include dopants such as alumina, aluminum oxide, or the like, to improve oxide toughness without changing the atomic arrangement of the layer 106. In effect, this produces a solid solution phase without changing the properties of the base material.

Referring now to FIG. 6, a method to protect a pre-coated substrate 102 from corrosion in a high-temperature aqueous environment in accordance with the present invention may comprise providing 600 a pre-coated substrate, providing 602 a non-porous ceramic oxide-based layer, applying 606 the ceramic oxide-based layer to the pre-coated substrate via non-vapor deposition, and, in some embodiments, sintering 608 the ceramic oxide-based layer 106. As discussed previously with reference FIG. 1, a pre-coated substrate 102 may comprise a ceramic, a ferrous or non-ferrous metal, stainless steel, a metal alloy, a metal superalloy, a nickel-based superalloy such as Haynes 230® superalloy, or the like.

Providing 602 a non-porous ceramic-oxide based layer 106 may comprise preparing an aqueous solution of a desired cation complex to act as a precursor for the desired final ceramic oxide-based layer. The aqueous solution may be prepared by dissolving high purity nitrate crystal in de-ionized water. The pH of the solution may be adjusted to maintain the stability of multiple nitrate precursors. The viscosity of the solution may be adjusted based on prior experience to provide good adhesion and uniform coating of the vapor-deposited coating and based on optimization of slip or slurry rheology and by establishing their wetting properties on substrates. In some embodiments, as discussed in more detail with reference to FIG. 7 below, providing 602 a non-porous ceramic oxide-based layer may include producing 604 nano-sized oxide materials for implementation in the ceramic oxide-based layer 106.

Applying 606 the ceramic oxide-based layer to the pre-coated substrate may comprise wetting a surface of the vapor-deposited coating 104 with a pre-dispersed, commercially available binding agent. As discussed previously with reference to FIG. 5 above, single or multiple coats of the aqueous solution comprising the ceramic oxide-based layer 106 may be applied by dip-coating, or by any other non-vapor deposition method known to those in the art. Each coat of the aqueous solution may be dried at a temperature below about forty degrees Celsius (40° C.) before sintering 608. Sintering 608 the ceramic oxide-based layer 106 may comprise setting a sintering temperature below about nine hundred degrees Celsius (900° C.) in an inert gas atmosphere such as nitrogen, hydrogen or argon. In some embodiments, the ceramic oxide-based layer 106 may be sintered 608 in an air atmosphere.

In another embodiment, a method to protect a pre-coated substrate from corrosion in a high-temperature aqueous environment, includes providing a pre-coated substrate having a substantially porous vapor-deposited coating, wherein the substantially porous vapor-deposited coating comprises a first coefficient of thermal expansion. At least one metal layer is provided that includes one of the group consisting of aluminum, magnesium, zinc, manganese, or tin. The method includes heating the pre-coated substrate with the top metal layer coating in order to oxidize the metal layer at higher temperature, wherein the resulting oxidized layer has a second coefficient of thermal expansion substantially matching the first coefficient of thermal expansion.

In one embodiment, providing the pre-coated substrate comprises providing a pre-coated substrate having a geometry selected from the group consisting of a planar geometry, a non-planar geometry, a tubular geometry, a three-dimensional geometry, and a complex geometry.

The metal layer can be applied via a non-vapor deposition technique comprises one of dip-coating, brush-coating, spraying, spin-coating, and wetting the pre-coated substrate. The substantially porous vapor-deposited coating comprises a coating applied by one of physical vapor deposition (“PVD”), evaporative deposition, electron-beam physical vapor deposition (“EB-PVD”), sputtering, pulsed laser deposition, high-velocity oxygen fuel thermal spraying, and plasma spray deposition. The metal layer is applied by one of physical vapor deposition (“PVD”), evaporative deposition, electron-beam physical vapor deposition (“EB-PVD”), sputtering, pulsed laser deposition, high-velocity oxygen fuel thermal spraying, and plasma spray deposition. In one embodiment, the at least one metal layer is applied using slurry or colloidal suspension comprises one of a colloidal suspension of metals comprising one of aluminum, magnesium, bronze, copper, zinc, manganese, or tin. In another embodiment, at least one layer is applied by a process comprising one of dip-coating, brush-coating, spraying, spin-coating, and wetting the pre-coated substrate.

The apparatus of claim 21, wherein the metal layer and the resulting oxidized layer comprises a thickness in a range between about 1 microns (1μ) and about 500 microns (500μ).

In one embodiment, the method includes sintering the oxidized metal layer at a temperature above the melting point of the metal. The sintering may include controlling a sintering temperature to facilitate an increased density of the resulting ceramic oxide-based layer. In one embodiment, sintering comprises setting a sintering temperature below about 1400° C.

Referring now to FIG. 7, certain embodiments of a method to protect a pre-coated substrate 102 from corrosion in a wide-temperature range, wet environment include producing 604 nano-sized oxide materials for implementation in the ceramic oxide-based layer 106. In one embodiment, for example, nano-sized particles of undoped MgO and MgO doped with, for example, ten volume percent (10 vol %) of ZrO2, CeO2 or CoO, may be produced. ZrO2 doping may be expected to increase transformation toughening of MgO, while CeO2 doping may provide chemical bonding and thermal expansion grading, and CoO doping may lower the sintering temperature of an MgO coating in an inert environment.

Producing 604 nano-sized oxide materials in accordance with certain embodiments of the present invention may include providing 700 an ammonium hydroxide solution, providing 702 a metal cation solution 702, and combining 704 the solutions to form a gelatinous precipitate. The solutions may be combined 704 by stirring with a magnetic stirrer using a peristaltic pump. The metal cation solution may be added to the ammonium hydroxide solution at a rate of about three (3) drops per second.

Producing 604 nano-sized oxide materials may further comprise converting 706 the precipitate to powder form. Specifically, in certain embodiments, the gelatinous precipitate may be washed in ethanol, filtered, and the solvent removed by grinding in a preheated mortar and pestle. The resulting material may be dried overnight in an oven at a temperature of about one hundred thirty degrees Celsius (130° C.). The dry cake may be calcined in a furnace at a temperature ranging from between about four hundred and about six hundred degrees Celsius (400-600° C.) for about three (3) hours to achieve the desired crystallographic phases.

To isolate 708 the supernatant, the calcined powder may be dispersed in water and ultrasonicated to remove large agglomerates (greater than about 400 nm) by decanting the top suspension and discarding the bottom solution. In one embodiment, the pH of the solution is adjusted, the solution is ultrasonicated for about nine (9) hours, and left to sit for about forty-eight (48) hours to remove agglomerates. Finally, the supernatant may be converted 710 to a final powder. Particularly, the supernatant may be dried, the soft agglomerates broken up by mortar and pestle, and then screened through a fine mesh screen to achieve the desired final powder. The final powder may be characterized according to surface area, crystallite size, particle size, agglomeration, chemical and phase purity to ensure its appropriateness for use as a component of the suspension or slurry used to apply the green ceramic oxide-based layer coating 106.

In one embodiment, synthesis of nano- and micron-sized oxide was accomplished by a standard co-precipitation method but with several modifications. The procedure followed to make individual single oxide or doped oxide compositions are described in flow chart of FIG. 7.

Nano-sized particles of undoped MgO and doped MgO (in one example) with 10 volume percent of ZrO₂ in MgO, CeO₂ in MgO and CoO in MgO were prepared by co-precipitation. In some cases ZrO₂ doping could increase transformation toughening of MgO, CeO₂ doping could provide chemical bonding and thermal expansion grading, and CoO doping could lower the sintering temperature of MgO coating in inert environment.

In the process of synthesizing MgO based nano-sized materials, stock solutions of metal cation nitrates were mixed with ammonium hydroxide solution under stirring conditions depending on single or doped oxide compositions. The gelatinous precipitate was washed in ethanol and dried. The dry cake was calcined at air furnace in the temperatures ranging from 250° C. to 600° C. to achieve the desired crystallographic phases. The calcined powder was dispersed in water and ultrasonicated to remove large agglomerates (>400 nm) by decanting the top suspension and discarding the bottom solution. The supernatant is dried and the soft agglomerates are broken up in a mortar and pestle, and then screen through a fine mesh screen to achieve the desired final powder.

Nitrate solutions, nano and micron suspensions (slurry) were prepared for applying the bond coat. An aqueous solution of the desired cation complex (precursor for the desired final oxide) is prepared by dissolving high purity nitrate crystal in de-ionized water. The pH of the solution is adjusted to maintain the stability of multiple nitrates precursors. The viscosity is adjusted based on prior experience to provide good adhesion and uniform coating. Pre-dispersed commercially available XUS binding agent will be used as a wetting agent for the alloy surface. Single or multiple coats will be applied by dip coating as per the development matrix. The coatings will be dried at temperature below 40° C. before sintering at 900° C. or below, in inert gas atmosphere (N₂, H₂, or Ar). Coatings were be fired in air to compare corrosion resistance and chemical stability.

In one embodiment, preparation of suspensions (slurries) of nano- and micron-sized MgO-based materials was accomplished by developing an organic solvent based suspension of nano- and micron-sized particles. Nano and submicron sized MgO based material was dispersed either in methyl alcohol or toluene-ethyl alcohol and other polar and non polar solvents. MgO based suspensions from 20 to 40% loading in toluene based solvent mixtures with poly vinyl butoral as a dispersant was established. The ingredients were mixed in a nalgene container with yttrium stabilized zirconium or alumina media half filled in the container. The slurry was de-aired by ultrasonic process and then flowing the slurry through a nitrogen feed to remove air bubbles. Viscosity of the solvent with loading of MgO up to 60% in the 5 to 20 cps range up to 200 cps was established. The benefits of the solvent based suspensions is discussed in the coating application and firing sections.

In parallel, effort was expended to also develop water based suspensions of nano- and micron-sized MgO and doped MgO materials. Suspensions (or slurry) of nano- and sub-micron particles of oxides were developed by performing experiments to disperse the oxide particles in a series of well known water soluble organic binders and dispersants (poly vinyl alcohol, -Darvin-C, commercially available chemical). Stable aqueous suspensions with oxide loading of 5 to 20 wt % were prepared using a commercially available Igepal-520 dispersing agent. The suspension rheology was studied by maintaining the viscosity in the 600 to 1200 cps range with 2% organics.

The coatings of MgO based suspensions were applied by automated dip coating method on the as-is or prepared surface of alloy by dipping into a solution or slurry bath filled in a beaker, and care was taken to control the speed of coater dipping and withdrawal rates at 0.4×10⁻⁴ m/s to obtain uniform green coating. The hold time in the solution, suspension viscosity and the plane of dipping of the substrates determines the quality, thickness and green bonding of as applied coatings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus having improved protection from various environments, the apparatus: comprising:
a pre-coated substrate having a substantially porous vapor-deposited coating, the vapor-deposited coating comprising a first coefficient of thermal expansion;
at least one ceramic oxide-based layer applied to the pre-coated substrate by a non-vapor deposition technique, wherein the at least one non-porous ceramic oxide-based layer provides a substantially hermetic seal limiting, gas, particulates and fluid access to the pre-coated substrate through the substantially porous vapor-deposited coating, the at least one ceramic oxide-based layer having a second coefficient of thermal expansion substantially matching the first coefficient of thermal expansion.

2. The apparatus of claim 1, wherein the ceramic oxide-base layer is non-porous.

3. The apparatus of claim 1, wherein the pre-coated substrate comprises a material selected from the group consisting of a ceramic, a ferrous metal, a non-ferrous metal, stainless steel, a metal alloy, a metal superalloy, and a Haynes 230® superalloy.

4. The apparatus of claim 1, wherein the pre-coated substrate comprises one of a planar and a non-planar geometry.

5. The apparatus of claim 1, wherein the substantially porous vapor-deposited coating comprises a vapor-deposited ceramic oxide-based coating.

6. The apparatus of claim 1, wherein the substantially porous vapor-deposited coating comprises a coating applied by one of physical vapor deposition (“PVD”), chemical vapor deposition (CVD), evaporative deposition, electron-beam physical vapor deposition (“EB-PVD”), sputtering, pulsed laser deposition, high-velocity oxygen fuel thermal spraying, and plasma spray deposition dip, brush, and spray coatings from suspension or slurries.

7. The apparatus of claim 1, wherein the at least one non-porous ceramic oxide-based layer comprises at least one of aluminum oxide, doped aluminum oxide, alumina-titania, magnesium oxide, doped magnesium oxide, zirconia, yttria-stabilized zirconia, magnesia-stabilized zirconia, yttria and ceria.

8. The apparatus of claim 1, wherein the at least one magnesium oxide-based layer further comprises a dopant selected from the group consisting of cobalt oxide, nickel oxide, zirconium oxide, cerium oxide, titanium oxide, iron-oxide, and aluminum oxide.

9. The apparatus of claim 1, wherein the at least one non-porous ceramic oxide-based layer comprises one of a colloidal suspension and a slurry.

10. The apparatus of claim 1, wherein the at least one non-porous ceramic oxide-based layer is applied by one of dip-coating, brush-coating, spraying, spin-coating, and wetting the pre-coated substrate.

11. The apparatus of claim 1, wherein the at least one non-porous ceramic oxide-based layer comprises a depth in a range between about 1 micron (1μ) and about five hundred microns (500μ).

12. The apparatus of claim 1, wherein the at least one non-porous ceramic oxide-based layer infiltrates pores of the substantially porous vapor-deposited coating at a depth in a range between about 1 micron (1μ) and about one hundred and fifty microns (150μ).

13. A method to protect a pre-coated substrate from corrosion in a high-temperature aqueous environment, the method comprising:
providing a pre-coated substrate having a substantially porous vapor-deposited coating, wherein the substantially porous vapor-deposited coating comprises a first coefficient of thermal expansion;
providing at least one non-porous ceramic oxide-based layer having a second coefficient of thermal expansion substantially matching the first coefficient of thermal expansion; and
applying, via a non-vapor deposition technique, the at least one non-porous ceramic oxide-based layer to the pre-coated substrate, to provide a hermetic seal limiting fluid access to the pre-coated substrate through the substantially porous vapor-deposited coating.

14. The method of claim 13, wherein the at least one non-porous ceramic oxide-based layer infiltrates pores of the substantially porous vapor-deposited coating.

15. The method of claim 13, wherein providing the pre-coated substrate comprises providing a pre-coated substrate having a geometry selected from the group consisting of a planar geometry, a non-planar geometry, a tubular geometry, a three-dimensional geometry, and a complex geometry.

16. The method of claim 13, wherein applying via a non-vapor deposition technique comprises one of dip-coating, brush-coating, spraying, spin-coating, and wetting the pre-coated substrate.

17. The method of claim 13, further comprising sintering the at least one non-porous ceramic oxide-based layer.

18. The method of claim 17, wherein sintering comprises controlling a sintering temperature to facilitate an increased density of the at least one non-porous ceramic oxide-based layer.

19. The method of claim 17, wherein sintering comprises setting a sintering temperature below about 1250° C.

20. The method of claim 13, further comprising controlling a depth at which the at least one non-porous ceramic oxide-based layer infiltrates pores of the substantially porous vapor-deposited coating.

21. The method of claim 20, wherein controlling the depth comprises varying at least one of an infiltration time, a cation concentration of the non-porous ceramic oxide-based layer, and a viscosity of the non-porous ceramic oxide-based layer.

22. An apparatus having improved protection in various environments, the apparatus produced by the steps of:
providing a pre-coated substrate having a substantially porous vapor-deposited coating, wherein the substantially porous vapor-deposited coating comprises a first coefficient of thermal expansion;
providing at least one non-porous ceramic oxide-based layer having a second coefficient of thermal expansion substantially matching the first coefficient of thermal expansion; and
applying, via a non-vapor deposition technique, the at least one non-porous ceramic oxide-based layer to the pre-coated substrate, wherein the at least one non-porous ceramic oxide-based layer infiltrates pores of the substantially porous vapor-deposited coating to provide a hermetic seal limiting fluid access to the pre-coated substrate through the substantially porous vapor-deposited coating.

23. The apparatus of claim 22, wherein applying the at least one non-porous ceramic oxide-based layer to the pre-coated substrate comprises at least one of dip-coating, brush-coating, spraying, spin-coating, and wetting the pre-coated substrate.

24. The apparatus of claim 22, the steps further comprising sintering the at least one non-porous ceramic oxide-based layer.

25. A method to protect a pre-coated substrate from corrosion in a high-temperature aqueous environment, the method comprising:
providing a pre-coated substrate having a substantially porous vapor-deposited coating, wherein the substantially porous vapor-deposited coating comprises a first coefficient of thermal expansion;
providing at least one metal layer from a group consisting of aluminum, magnesium, zinc, manganese, copper, bronze, tin, and combinations thereof; and
heating the pre-coated substrate with the top metal layer coating in order to oxidize the metal layer at higher temperature, wherein the resulting oxidized layer has a second coefficient of thermal expansion substantially matching the first coefficient of thermal expansion.

26. The method of claim 25, wherein providing the pre-coated substrate comprises providing a pre-coated substrate having a geometry selected from the group consisting of a planar geometry, a non-planar geometry, a tubular geometry, a three-dimensional geometry, and a complex geometry.

27. The method of claim 25, wherein the metal layer can be applied via a non-vapor deposition technique comprises one of dip-coating, brush-coating, spraying, spin-coating, and wetting the pre-coated substrate.

28. The method of claim 25, wherein the substantially porous vapor-deposited coating comprises a coating applied by one of physical vapor deposition (“PVD”), evaporative deposition, electron-beam physical vapor deposition (“EB-PVD”), sputtering, pulsed laser deposition, high-velocity oxygen fuel thermal spraying, and plasma spray deposition.

29. The method of claim 25, wherein the metal layer is applied by one of physical vapor deposition (“PVD”), evaporative deposition, electron-beam physical vapor deposition (“EB-PVD”), sputtering, pulsed laser deposition, high-velocity oxygen fuel thermal spraying, and plasma spray deposition.

30. The method of claim 25, further comprising sintering the oxidized metal layer at a temperature above the melting point of the metal.

31. The method of claim 30, wherein sintering comprises controlling a sintering temperature to facilitate an increased density of the resulting ceramic oxide-based layer.

32. The method of claim 30, wherein sintering comprises setting a sintering temperature below about 1400° C.

33. The method of claim 25, wherein the at least one metal layer is applied using slurry or colloidal suspension comprises one of a colloidal suspension of metals comprising one of aluminum, magnesium, bronze, copper, zinc, manganese, or tin.

34. The method of claim 25, wherein the at least one layer is applied by a process comprising one of dip-coating, brush-coating, spraying, spin-coating, and wetting the pre-coated substrate.

35. The apparatus of claim 25, wherein the metal layer and the resulting oxidized layer comprises a thickness in a range between about 1 microns (1μ) and about 500 microns (500μ).
